(19) United States
(12) Patent Application Publication
(10) Pub. No.: US 2016/0245348 A1
(43) Pub. Date: Aug. 25, 2016

(54) DIH TYPE PARKING BRAKE APPARATUS

(71) Applicant: Hyundai Motor Company, Seoul (KR)

(72) Inventors: Sun-Joo KIM, Suwon-si (KR); Eung-Jun CHA, Gwangmyeong-si (KR)

(73) Assignee: Hyundai Motor Company, Seoul (KR)

(21) Appl. No.: 14/930,454

(22) Filed: Nov. 2, 2015

(30) Foreign Application Priority Data
Feb. 25, 2015 (KR) 10-2015-0026423

(51) Int. Cl. F16D 51/10; F16D 65/14; B60T 1/06

(52) U.S. Cl. CPC F16D 51/10; B60T 1/067; F16D 65/14

(57) ABSTRACT

A drum-in-hat (DIH) type parking brake apparatus including a drum which is integrally coupled to and is rotated along with an axle of a vehicle, a brake shoe installed to a vehicle body so as to come into contact with the drum, and an actuation device for spreading the brake shoe such that the brake shoe comes into contact with the drum may include rods slidably disposed on the actuation device so as to press end portions of the brake shoe while extending from the actuation device during braking, and movement restriction devices vertically formed on front surfaces of the rods so as to prevent the end portions of the brake shoe from dropping or rising when the vehicle is braked.

### CROSS-REFERENCE TO RELATED APPLICATIONS

The present application claims priority to Korean Patent Application No. 10-2015-0026423, filed Feb. 25, 2015, the entire contents of which is incorporated herein for all purposes by this reference.

### BACKGROUND OF THE INVENTION

1. Field of the Invention

Various embodiments of the present invention relate to a parking brake apparatus of a vehicle; and, particularly, to a drum-in-hat (DIH) type parking brake apparatus capable of reducing a torque deviation at a shoe during braking.

2. Description of Related Art

A DIH type parking brake 100 as one of parking brakes of vehicles, as illustrated in FIG. 1, includes a dust cover 111 and a torque plate 112 which are mounted to a knuckle (or a carrier) portion of a wheel and are connected with a parking cable or a hydraulic line. In addition, the DIH type parking brake 100 includes a pair of brake shoes 114, each having a semicircular shape and a lining 114a, or one brake shoe 114 which has a ring shape opened at a portion thereof and a lining 114a. When actuation force is input to the brake from the parking cable or the hydraulic line, the brake shoe(s) 114 is/are spread outward so as to exhibit braking force.

FIG. 1 is a perspective view illustrating a DIH type parking brake apparatus 100 equipped with one brake shoe 114. When an oil pressure is provided to a piston 113, the brake shoe 114 is spread while rods 115 installed to both ends of the piston 113 extend, thereby allowing braking force to be exhibited. The rods 115 installed to both left and right sides of the piston 113 have catching portions 115b formed to prevent end portions of the brake shoe 114 from being detached only in the left and right directions.

The above DIH type parking brake apparatus according to the related art is not provided with a means for preventing one-sided contact of the brake shoe 114. That is, a rotational moment is applied to the brake shoe 114 during braking, so that one-sided contact is generated at any end portion of the brake shoe 114 while the end portion of the brake shoe 114 drops or rises, resulting in generation of uneven wear and torque concentration.

For example, when a counterclockwise rotational moment is applied to the brake shoe 114, one-sided contact is generated while the end portion of the brake shoe 114 coming into contact with the left end of the piston 113 drops and the end portion of the brake shoe 114 coming into contact with the right end of the piston 113 rises, as illustrated in FIG. 1 and FIG. 2.

Due to such one-sided contact, uneven wear is generated in the lining 114a coming into contact with the brake shoe 114 at a portion of the brake shoe 114 located behind the piston 113 in a rotation direction (that is, a portion located to the right of the piston), and a phenomenon in which torque is concentrated on a portion of the brake shoe 114 is generated as indicated by a torque diagram in FIG. 2. Due to the torque deviation as described above, a braking force deviation is generated at the left and right end portions of the brake shoe 114, thereby causing the brake apparatus to fail to pass certification of various regulations.

However, since the DIH type parking brake apparatus according to the related art is not provided with a means for preventing drop or rise of the end portions of the brake shoe 114, the above-mentioned phenomenon is consistently generated. That is, the rods 115 coming into contact with the end portions of the brake shoe 114 have the catching portions 115b formed to prevent the end portions of the brake shoe 114 from being detached only in the left and right directions, but is not provided with a means for preventing vertical movement of the end portions of the brake shoe 114 in the rods 115.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a DIH type parking brake apparatus capable of reducing one-sided contact of a brake shoe by preventing drop or rise of end portions of the brake shoe during braking.

Various aspects of the present invention are directed to providing a DIH type parking brake apparatus capable of preventing a phenomenon in which torque is concentrated on a portion of a brake shoe by preventing drop or rise of end portions of the brake shoe during braking.

According to various aspects of the present invention, a drum-in-hat (DIH) type parking brake apparatus including a drum which is integrally coupled to and is rotated along with an axle of a vehicle, a brake shoe installed to a vehicle body so as to come into contact with the drum, and an actuation device for spreading the brake shoe such that the brake shoe comes into contact with the drum may include rods slidably disposed on the actuation device so as to press end portions of the brake shoe while extending from the actuation device during braking, and movement restriction devices vertically formed on front surfaces of the rods so as to prevent the end portions of the brake shoe from dropping or rising when the vehicle is braked.

One of the movement restriction devices may be a drop prevention stopper formed at a lower portion of the front surface of the associated rod to prevent the associated end portion of the brake shoe from dropping.

The drop prevention stopper may be formed at the rod coming into contact with the end portion of the brake shoe located in front of a piston as the actuation device in a rotation direction of a wheel during the braking.

The drop prevention stopper may have an inclined surface formed to be inclined relative to a surface perpendicular to a sliding direction of the rod so as to support a lower end of the end portion of the brake shoe.

The drop prevention stopper may be formed at an inclination angle of 18° to 22° to the surface perpendicular to the sliding direction of the rod.

One of the movement restriction devices may be a rise prevention stopper formed at an upper portion of the front surface of the associated rod to prevent the associated end portion of the brake shoe from rising.

The rise prevention stopper may be formed at the rod coming into contact with the end portion of the brake shoe located behind a piston as the actuation device in a rotation direction of a wheel during the braking.

The rise prevention stopper may have an inclined surface formed to be inclined relative to a surface perpendicular to a sliding direction of the rod so as to support an upper end of the end portion of the brake shoe.

The rise prevention stopper may be formed at an inclination angle of 18° to 22° to the surface perpendicular to the sliding direction of the rod.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view illustrating a drum-in-hat (DIH) type parking brake apparatus according to the related art.

FIG. 2 is a front view illustrating the DIH type parking brake apparatus according to the related art.

FIG. 3 is an enlarged perspective view illustrating an installation portion of a piston in the DIH type parking brake apparatus according to the related art.

FIG. 4 is a perspective view illustrating one rod installed between a brake shoe and the piston in the DIH type parking brake apparatus according to the related art.

FIG. 5 is an enlarged perspective view illustrating an installation portion of a piston in an exemplary DIH type parking brake apparatus according to the present invention.

FIG. 6 is a front view illustrating the DIH type parking brake apparatus according to the present invention.

FIG. 7 and FIG. 8 are cross-sectional views illustrating respective rods between a brake shoe and the piston in the exemplary DIH type parking brake apparatus according to the present invention.

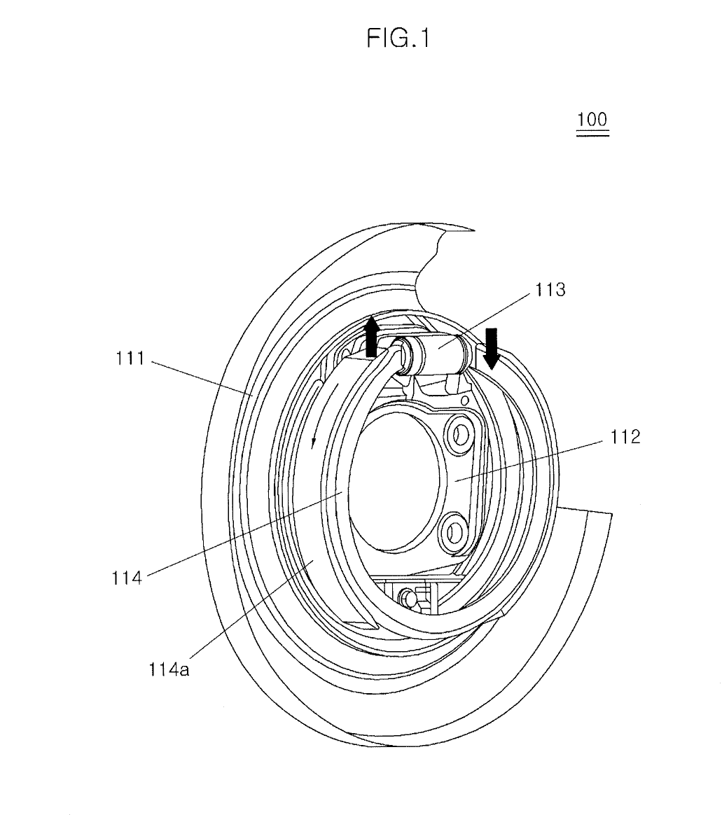

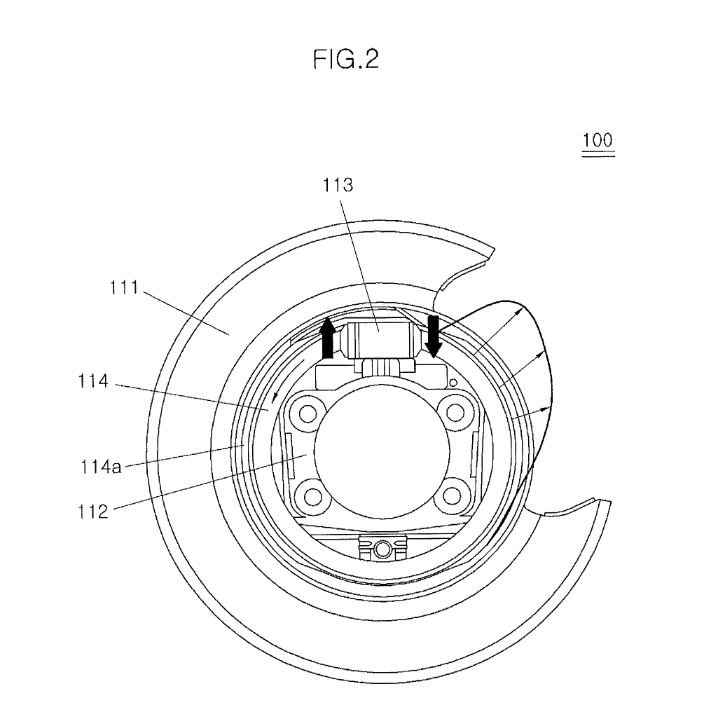

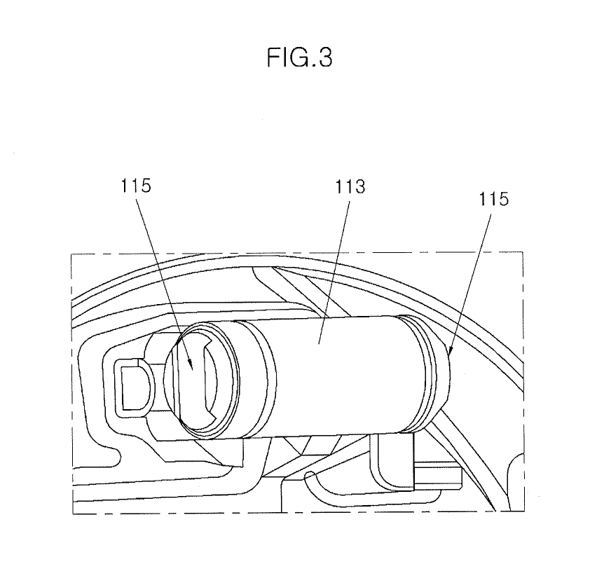

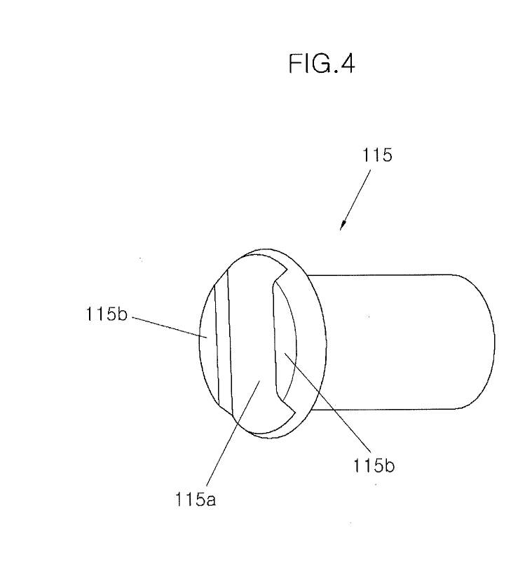

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A drum-in-hat (DIH) type parking brake apparatus according to various embodiments of the present invention includes a drum which is integrally coupled to and is rotated along with an axle of a vehicle, a brake shoe 14 installed to a vehicle body so as to come into contact with the drum, and an actuation device for spreading the brake shoe 14 such that the brake shoe 14 comes into contact with the drum. The DIH type parking brake apparatus includes rods which are slidably installed to the actuation device and press end portions of the brake shoe 14 while extending from the actuation device during braking, and movement restriction devices which are vertically formed on front surfaces of the rods 15 and 16 so as to prevent drop or rise of the end portions of the brake shoe 14 when the vehicle is braked.

The DIH type parking brake apparatus 1 includes the drum (not shown) rotated along with the axle and the brake shoe 14 fixedly installed to the vehicle body. The brake shoe 14 is spread such that the brake shoe 14 comes into close contact with the drum and then a lining 14a installed on an outside surface of the brake shoe 14 comes into contact with an inside surface of the drum, thereby allowing braking force to be exhibited.

The brake shoe 14 has a ring shape and a partial section of the brake shoe 14 may be removed such that the actuation device for spreading the brake shoe 14 is located at the partial section. The brake shoe 14 may be formed integrally with a torque plate 12 coupled to a dust cover 11 of the DIH type parking brake apparatus 1.

The actuation device for spreading the brake shoe 14 may be a piston 13 for spreading the brake shoe 14 while extending by an oil pressure.

The rods 15 and 16 are fitted to both ends of the piston 13 and slide outward when the pressurized oil pressure acts on the piston 13, so that the rods 15 and 16 come into contact with the respective end portions of the brake shoe 14.

In the present invention, when the pressurized oil is supplied to the piston 13, the movement restriction devices for preventing movement of the brake shoe 14, namely, for preventing drop or rise of the end portions of the brake shoe 14 are respectively formed at the rods 15 and 16 which slide and protrude from the piston 13.

The stationary brake shoe 14 comes into contact with the rotating drum and the brake shoe 14 rotates in a rotation direction of a wheel, during braking. In this case, the respective end portions of the brake shoe 14 coming into contact with the rods 15 and 16 drop or rise.

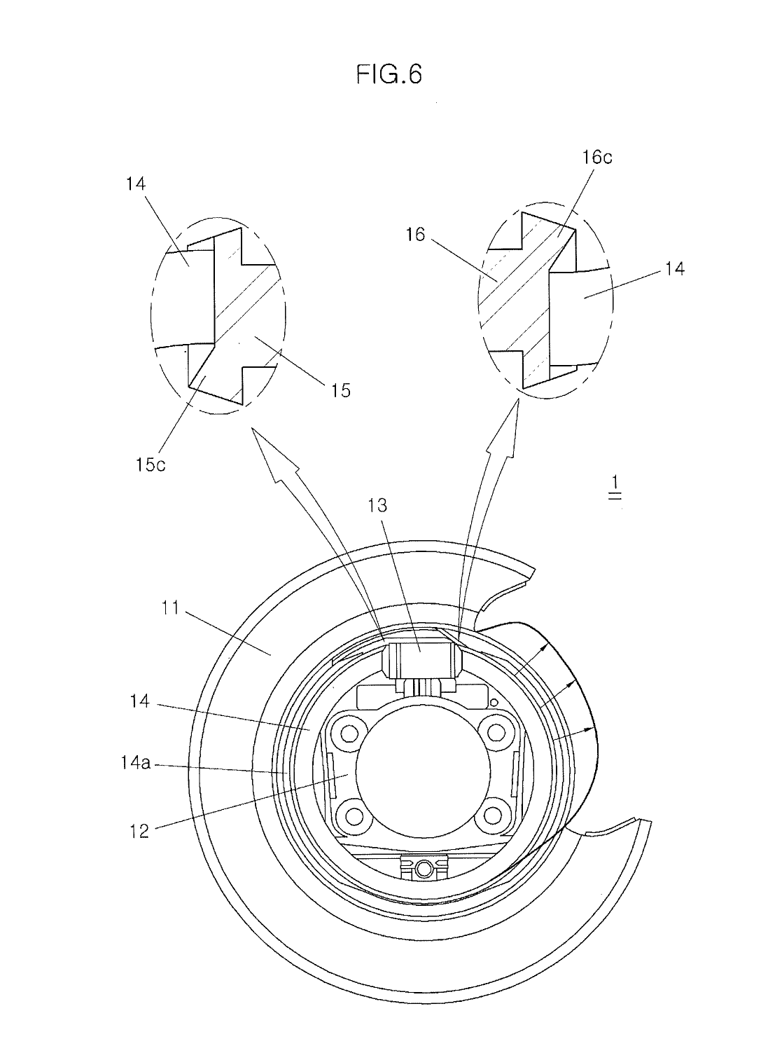

That is, the end portion of the brake shoe 14 located in front of the piston 13 in the rotation direction of the wheel (the end portion of the brake shoe 14 located at the left in FIG. 6) drops, whereas the other end portion (the end portion located at the right in FIG. 6) rises.

In order to prevent this, the movement restriction devices for preventing drop or rise of the end portions of the brake shoe 14 are installed to the rods 15 and 16.

When the end portions of the brake shoe 14 drop or rise, the movement restriction devices may prevent the end portions of the brake shoe 14 from dropping or rising by forming lower or upper portions of the front surfaces of the rods 15 and 16 coming into contact with the end portions of the brake shoe 14 at higher locations than portions coming into contact with the end portions of the brake shoe 14.

For example, the movement restriction devices may be a drop prevention stopper 15c or a rise prevention stopper 16c.

First, the drop prevention stopper 15c will be described below.

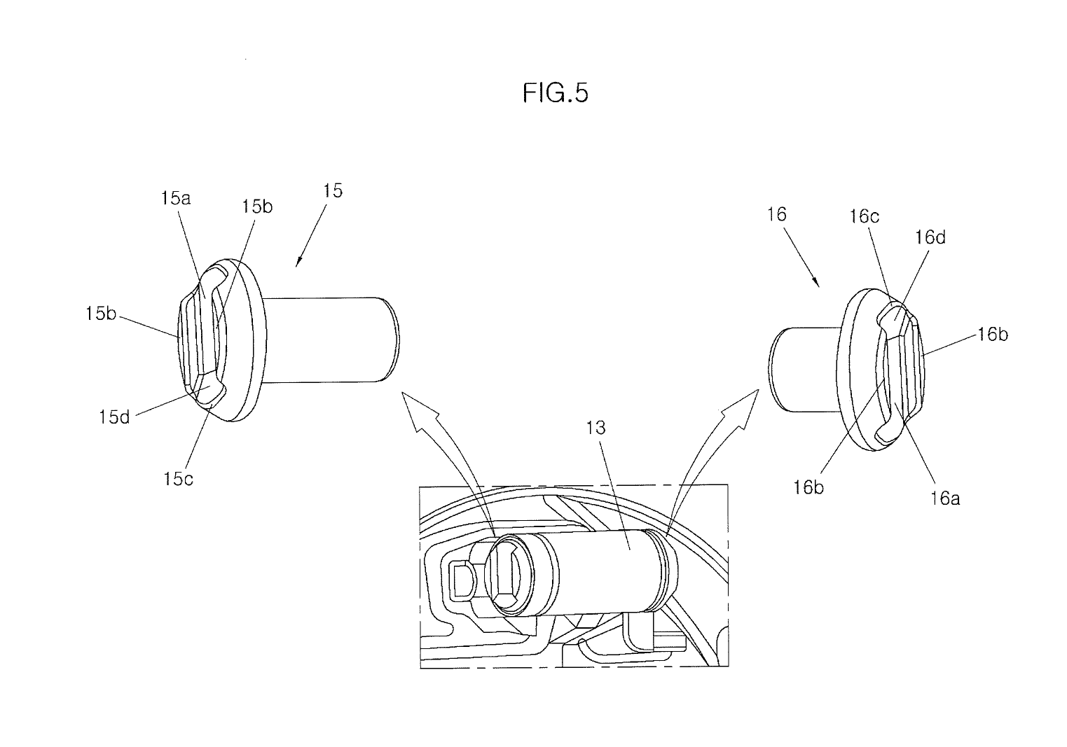

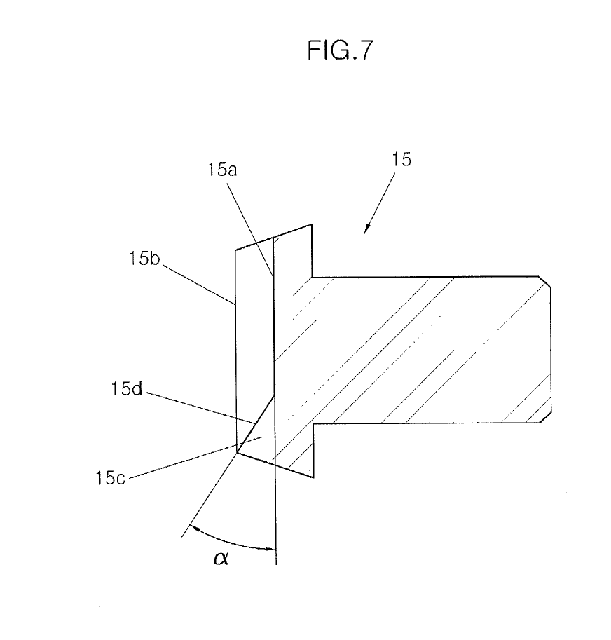

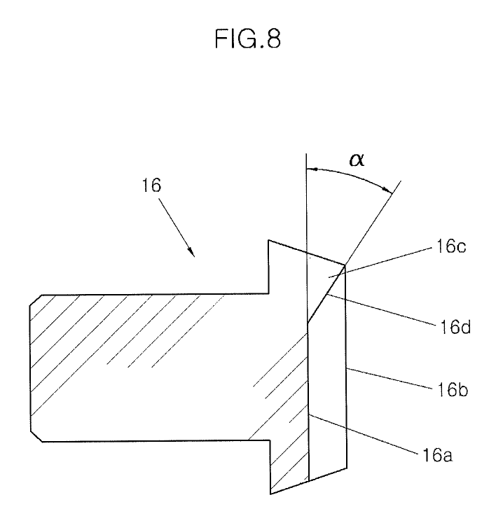

The drop prevention stopper 15c is formed to protrude from the front surface of the rod 15 so as to prevent the associated end portion of the brake shoe 14 from dropping. As illustrated in detail in FIG. 5 and FIG. 7, the rod 15 has a seating surface 15a which is formed on the front surface thereof to come into contact with the end portion of the brake shoe 14, and a catching portion 15b which is formed to prevent the end portion of the brake shoe 14 from being detached from the seating surface 15a in a left and right direction of the seating surface 15a (in a width direction of the vehicle). In this case, the drop prevention stopper 15c protrudes from a lower portion of the seating surface 15a so as to fill a gap between the lower portion of the seating surface 15a and the catching portion 15b. The drop prevention stopper 15c has an inclined surface 15d formed at a certain angle to the seating surface, and the inclined surface 15d may have an inclination angle α of about 20°, for example, an inclination angle α of 18° to 22°.

As illustrated in FIG. 6, the drop prevention stopper 15c supports a lower end of the end portion of the brake shoe 14, thereby allowing the end portion of the brake shoe 14 to be prevented from dropping.

Thus, the drop prevention stopper 15c is formed at the rod 15 coming into contact with the dropping end portion of the end portions of the brake shoe 14 during braking, namely, is formed at the rod 15 coming into contact with the brake shoe 14 located in front of the piston 13 in the rotation direction.

The rise prevention stopper 16c is formed at the rod 16 located opposite to the rod 15 formed with the drop prevention stopper 15c, from among the two rods 15 and 16 installed to the piston 13.

The rise prevention stopper 16c is formed at the rod 16 coming into contact with the rising end portion of the end portions of the brake shoe 14 during braking, namely, is formed at the rod 16 coming into contact with the brake shoe 14 located behind the piston 13 in the rotation direction.

The rise prevention stopper 16c may be formed in a manner similar to the drop prevention stopper 15c. However, the portion at which the rise prevention stopper 16c is formed differs from that of the rise prevention stopper 16c since the rise prevention stopper 16c prevents the end portion of the brake shoe 14 from rising.

That is, the rod 16 has a seating surface 16a formed on the front surface thereof to seat the end portion of the brake shoe 14 and a catching portion 16b formed in a left and right direction of the seating surface 16a, and the rise prevention stopper 16c protrudes from a upper portion of the seating surface 16a so as to fill a gap between the upper portion of the seating surface 16a and the catching portion 16b.

The rise prevention stopper 16c also has an inclined surface formed at a certain inclination angle α to the seating surface 16a. The inclination angle α may be an angle of about 20°, for example, an angle of 18° to 22°. The inclination angle formed by the inclined surface 16d of the rise prevention stopper 16c may be similar to or differ from the inclination angle formed by the inclined surface 15d of the drop prevention stopper 15c.

An operation of the DIH type parking brake apparatus having the above-mentioned configuration according to various embodiments of the present invention will be described below.

When the vehicle is braked, a rotational moment is applied to the brake shoe 14 in the rotation direction of the wheel of the vehicle and thus the end portions of the brake shoe 14 drop or rise by the rotational moment.

For example, when a counterclockwise rotational moment is applied to the brake shoe 14, dropping force acts on the end portion of the brake shoe 14 located in front of the piston 13 (at the left in FIG. 6) in the rotation direction and rising force acts on the end portion of the brake shoe 14 located behind the piston 13 (at the right in FIG. 6) in the rotation direction.

However, as shown in FIG. 6, since the end portions of the brake shoe 14 are caught by the drop prevention stopper 15c and the rise prevention stopper 16c formed at the respective rods 15 and 16, the end portions of the brake shoe 14 are prevented from dropping or rising to be maintained at the initial positions.

As described above, since the brake shoe 14 is maintained at the initial position even though the vehicle is braked, the brake shoe 14 relatively uniformly comes into contact with the drum. Through such a configuration, since the present invention has a torque distribution such as the torque diagram illustrated in FIG. 6, a torque deviation is reduced compared to the related art.

In addition, since the torque deviation is reduced at the brake shoe 14 and the braking force is uniformly exhibited in the brake shoe 14, the DIH type parking brake apparatus may pass various types of certification and prevent uneven wear of the brake shoe 14.

In accordance with various embodiments of the present invention, a DIH type parking brake apparatus can prevent one-sided contact of a brake shoe by preventing drop or rise of end portions of the brake shoe from rods extending from a piston during braking such that the brake shoe is maintained at an initial installation position.

In addition, since the one-sided contact of the brake shoe is prevented, a phenomenon in which torque is concentrated on a portion of the brake shoe can be reduced and thus a deviation between braking forces generated at left and right end portions of the brake shoe can be reduced.

In addition, since the one-sided contact of the brake shoe is reduced, it is possible to prevent uneven wear due to the one-sided contact.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings.

The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A drum-in-hat (DIH) type parking brake apparatus including a drum which is integrally coupled to and is rotated along with an axle of a vehicle, a brake shoe installed to a vehicle body so as to come into contact with the drum, and an actuation device for spreading the brake shoe such that the brake shoe comes into contact with the drum, the DIH type parking brake apparatus comprising:
rods slidably disposed on the actuation device so as to press end portions of the brake shoe while extending from the actuation device during braking; and
movement restriction devices vertically formed on front surfaces of the rods so as to prevent the end portions of the brake shoe from dropping or rising when the vehicle is braked.

2. The DIH type parking brake apparatus of claim 1, wherein one of the movement restriction devices is a drop prevention stopper formed at a lower portion of the front surface of the associated rod to prevent the associated end portion of the brake shoe from dropping.

3. The DIH type parking brake apparatus of claim 2, wherein the drop prevention stopper is formed at the rod coming into contact with the end portion of the brake shoe located in front of a piston as the actuation device in a rotation direction of a wheel during the braking.

4. The DIH type parking brake apparatus of claim 2, wherein the drop prevention stopper has an inclined surface formed to be inclined relative to a surface perpendicular to a sliding direction of the rod so as to support a lower end of the end portion of the brake shoe.

5. The DIH type parking brake apparatus of claim 4, wherein the drop prevention stopper is formed at an inclination angle of 18° to 22° to the surface perpendicular to the sliding direction of the rod.

6. The DIH type parking brake apparatus of claim 1, wherein one of the movement restriction devices is a rise prevention stopper formed at an upper portion of the front surface of the associated rod to prevent the associated end portion of the brake shoe from rising.

7. The DIH type parking brake apparatus of claim 6, wherein the rise prevention stopper is formed at the rod coming into contact with the end portion of the brake shoe located behind a piston as the actuation device in a rotation direction of a wheel during the braking.

8. The DIH type parking brake apparatus of claim 6, wherein the rise prevention stopper has an inclined surface formed to be inclined relative to a surface perpendicular to a sliding direction of the rod so as to support an upper end of the end portion of the brake shoe.

9. The DIH type parking brake apparatus of claim 8, wherein the rise prevention stopper is formed at an inclination angle of 18° to 22° to the surface perpendicular to the sliding direction of the rod.
